(19) United States
(12) Patent Application Publication
(10) Pub. No.: US 2008/0282017 A1
(43) Pub. Date: Nov. 13, 2008

(54) Serial Peripheral Interface Switch

(75) Inventors: Todd L. Carpenter, Monroe, WA (US); William J. Westerinen, Issaquah, WA (US); Shon Schmidt, Seattle, WA (US); Stephen Richard Drake, Seattle, WA (US); Tse-Ching James Yu, Woodinville, WA (US); Achim Schmidt, Muenchen (DE); Stephan Schoenfeldt, Muenchen (DE); Frank Preiss, Landsberg (DE)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/746,268

(22) Filed: May 9, 2007

(51) Int. Cl. G06F 13/38

(52) U.S. Cl. 710/316

(57) ABSTRACT

An SPI switch allows selection of a BIOS memory transparent to a Southbridge chipset component. The SPI switch provides address translation to a selected BIOS memory area under the control of a security module processor. The SPI switch also provides command filtering to prevent commands that represent a security risk such as bulk erase commands. Because the SPI switch allows transparent redirection between BIOS programs, booting in different operating modes may be supported without any changes to the basic computer architecture or major chipset components.

### BACKGROUND

Personal and enterprise computers are well defined and follow a standard, if not complex, set of protocols during operation. Attempts to force operation of a computer into a different process may require alternation of not only the operating programs used but also the hardware, such as chipset components.

For example, a typical computer architecture uses a processor, a Northbridge chip, and a Southbridge chip in a known configuration. These three components are often referred to a the chipset of a computer. During a system restart, this configuration also helps define a startup process where the Southbridge accesses a known memory address to load a basic input/output system (BIOS) program used to startup the computer.

Attempting to use a BIOS memory from another part of the system architecture may require circuit-level changes to one or more chips. However, the cost of designing and manufacturing new chipset components is significant. When it is desirable to alter the basic operation of a computer, a designer must make choices that depend on effectiveness and cost.

### SUMMARY

A computer that operates in two modes, one, a full operation mode and a second, limited function mode may be used for metered use applications. The full operation, or unrestricted mode, may be used for normal operation. A metering capability may monitor usage and determine if the computer has been used beyond paid-up services, either a subscription period or per-time unit usage. When the computer is no longer authorized for full operation, the computer may operate in a restricted mode that only allows enough functionality to enter a proof of payment token, such as a code number.

Other embodiments of dual mode operation may include pay-per-performance computers, where additional processors or memory become available upon receipt of a payment verification token.

To support multiple operating modes, a standard computer architecture may be modified slightly so that standard chipsets and operational protocols may be followed, but standard memory calls, such as to the BIOS memory may be transparently processed under the control of a security device that determines the operating mode. The security module may use a switch that presents data to the calling party in a normal manner, but transparently switches access a BIOS program selected by the security module. Because the calling party, such as an I/O controller, or Southbridge, may have no knowledge that something other than a normal memory is present, the security module, or switch itself, may need to filter memory commands that could potentially interfere with the modified operation, such as a bulk erase command.

A particular embodiment of the security module may be connected to a serial peripheral interface (SPI) bus that is commonly used to connect a Southbridge chip to BIOS memory.

### BRIEF DESCRIPTION OF THE DRAWINGS

FIG. 1 is a simplified and representative block diagram of a computer;

FIG. 2 is a simplified and representative block diagram of a security module with switch matrix;

FIG. 2A is a simplified and representative block diagram of an alternate configuration of the security module of FIG. 2;

FIG. 3 is a simplified and exemplary block diagram of a switch matrix; and

FIG. 4 is a timing diagram showing command filtering.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

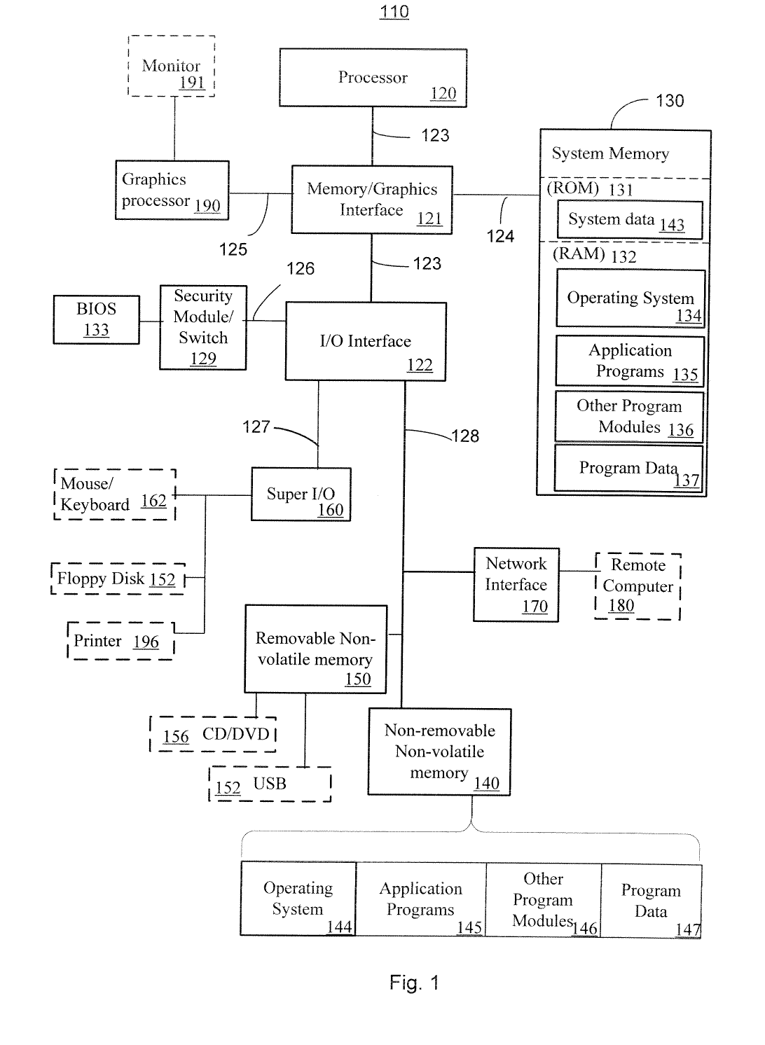

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a main processor 120, a system memory 130, a memory/graphics interface 121, also known as a Northbridge chip, and an I/O interface 122, also known as a Southbridge chip. A memory 130 and a graphics processor 190 may be coupled to the memory/graphics interface 121. A monitor 191 or other graphic output device may be coupled to the graphics processor 190.

A series of system busses may couple various these system components including a high speed system bus 123 between the main processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 121 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

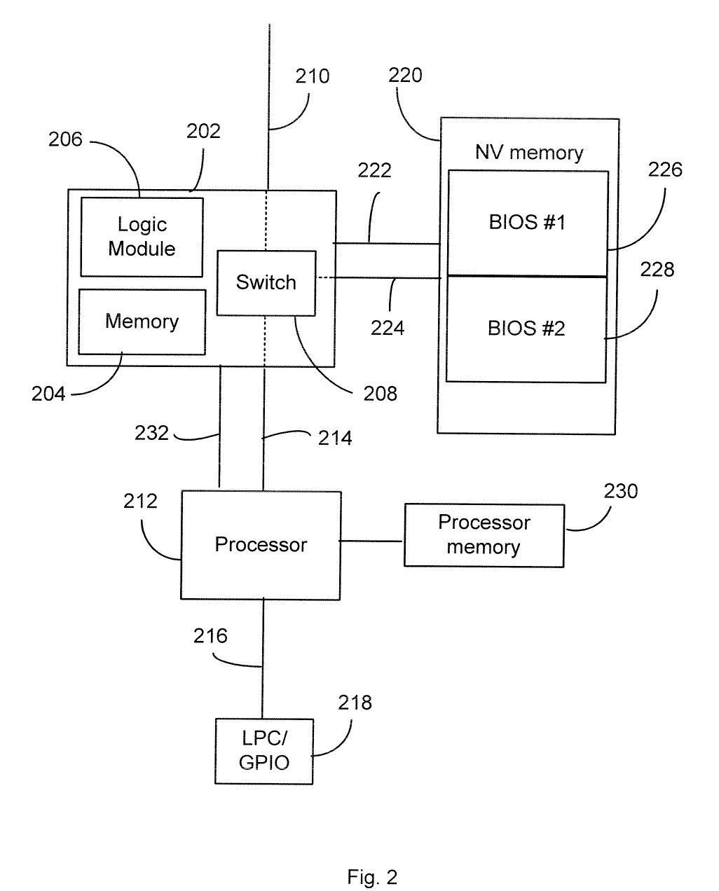

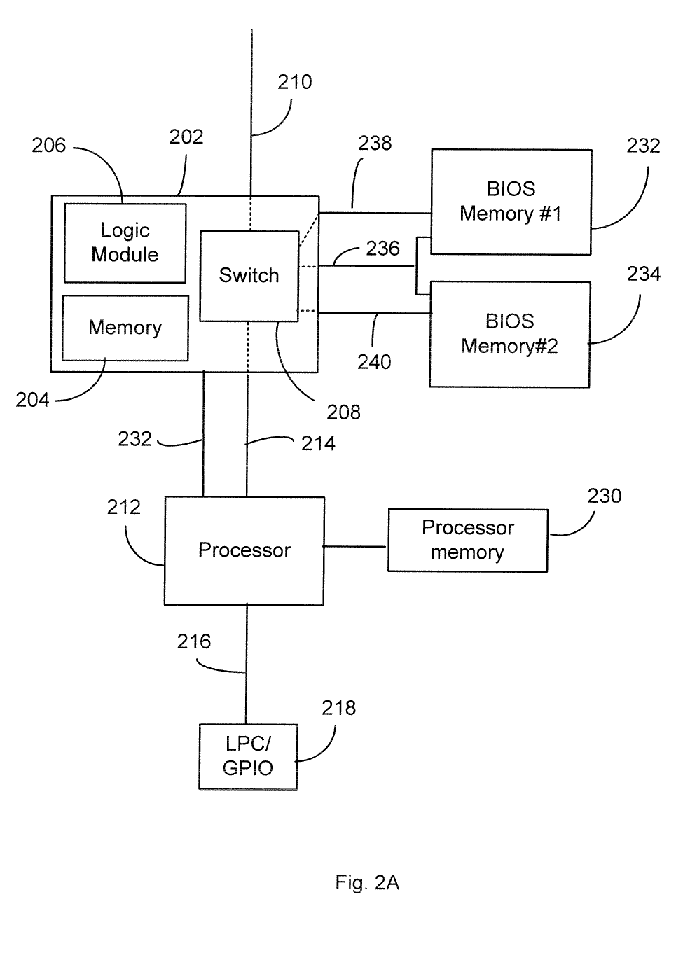

A security module 129 may be deployed and configured to enforce the terms of an agreement between a user of the computer 110 and a service provider with an interest in the computer 110. The security module 129 may be instantiated in more than one manner. When implemented by one or more discrete components, the security module 129 may be disposed on the motherboard (not depicted) or in a multi-chip module (MCM) that is, itself, disposed on the motherboard. The security module 129 is discussed in more detail below with respect to FIG. 2 and may include an SPI switch.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by main processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 128 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 122 may be connected to the I/O interface 121 with a low pin count (LPC) bus, in some embodiments. The super I/O chip is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection depicted in FIG. 1 may include a local area network (LAN), a wide area network (WAN), or both, but may also include other networks. Such networking environments are commonplace in offices, enterprise-wide computer networks, intranets and the internet.

In some embodiments, the network interface may use a modem (not depicted) when a broadband connection is not available or is not used. It will be appreciated that the network connection shown is exemplary and other means of establishing a communications link between the computers may be used.

FIG. 2 is a block diagram of a simplified and representative security module 200, similar to the security module 129 of FIG. 1. The security module 200 may have a switch matrix 202 that may include a memory 204 and a logic module 206. The logic module 206 may perform, among other functions, address translation and command filtering. A switch 208 may be a single switch or may be a series of individual switches depending on the actual bus topology supported. For example, when the bus is a serial peripheral interface (SPI), each of the six data and control signals may be controlled independently.

The module 200 may also include a bus 210 for connection to an external component, such as an I/O interface 122 of FIG. 1. A processor 212 may be connected to the switch matrix 202 by a bus interface 214. The processor 212 may be connected by one or more buses 216 to a low pin count (LPC) bus, a general-purpose interface (GPIO) 218 or other known interface or combination. In nonvolatile memory 220 may be connected to the switch matrix 202 with one or more connections 222, 224 that may include both address and data connections. The nonvolatile memory 220 may include a basic input output system (BIOS) 226. In some embodiments, a second BIOS 228 may also be included in the nonvolatile memory 220. When more than one BIOS is present, each may have a specific application, for example the first BIOS 226 may be for normal operation in the second BIOS 228 may be used during restricted mode operation.

The processor 212 may execute from processor memory 230 that may be in a separate memory dedicated to the processor 212 or the processor memory 230 may be part of the nonvolatile memory 220. Because the processor 212 relates to overall security of an electronic device incorporating the security module 200, the processor memory 230 may be well protected from tampering.

In operation, the processor 212 may store a setting related to next boot operation in the processor memory 230. During the boot cycle the processor may determine whether the first BIOS 226 or the second BIOS 228 should be presented to a requesting entity over the bus 210. In another embodiment, the processor 212 may be responsible for operation in may restricted mode, and may access one of the BIOS memories 226, 228 for start up instructions as would the electronic device's main processor. In such an embodiment, processor 212 may not only receive data from one of BIOS memories 226, 228 via switch 208, but may also manage settings and information in memory 204 via a processor interface 232.

When the switch 208 is set so as to connect the nonvolatile memory 222 the bus 210, memory access directed to a particular address may actually be substituted for a different address in the nonvolatile memory 220 in order to accomplish the goals required by the selected operating mode.

In addition, certain requests received over the bus 210 may not be allowable. For example, an I/O interface 122 may routinely perform a number of maintenance functions such as BIOS updates. A BIOS update may include a request for a memory type, allowing the I/O interface 122 to determine how much memory is available followed by a bulk erase command that would clear memory to make way for the update. Because the switch matrix 202 and multiple instances of BIOS 226, 228 are transparent to the I/O interface 122, commands such as a bulk erase, or even a device type request may be blocked by the switch matrix 202 and are replied to with either an error or a generic response.

FIG. 2A illustrates an alternate form of the security module of FIG. 2. Rather than a single non-volatile memory 220 of FIG. 2, FIG. 2A illustrates that two separate memories 232 and 234 may be connected to the switch matrix 202. A modification to the switch matrix 202 may be required, depending on the bus configuration. For example, an SPI bus may use a single control bus 236 and separate chip select lines 238 and 240.

In operation, a requesting entity 210, such as the I/O interface 122 may make a standard request to a known address. As described in more detail below, the switch matrix 202 may determine, based on operating mode or another condition, that the requested address is to a non-authorized memory, for example, BIOS memory 232. When that is the case, the switch matrix 202 may substitute an alternate address. In this configuration, the address substitution may involve selecting the chip select 240 for an alternate BIOS memory 234. In this manner, the requesting party coupled to bus 210 may not be aware that more than one memory is present. The processor 212 may be aware of the memory configuration but can address the separate memories 232 and 234 over the bus interface 214 or the processor interface 232 or a combination of the two.

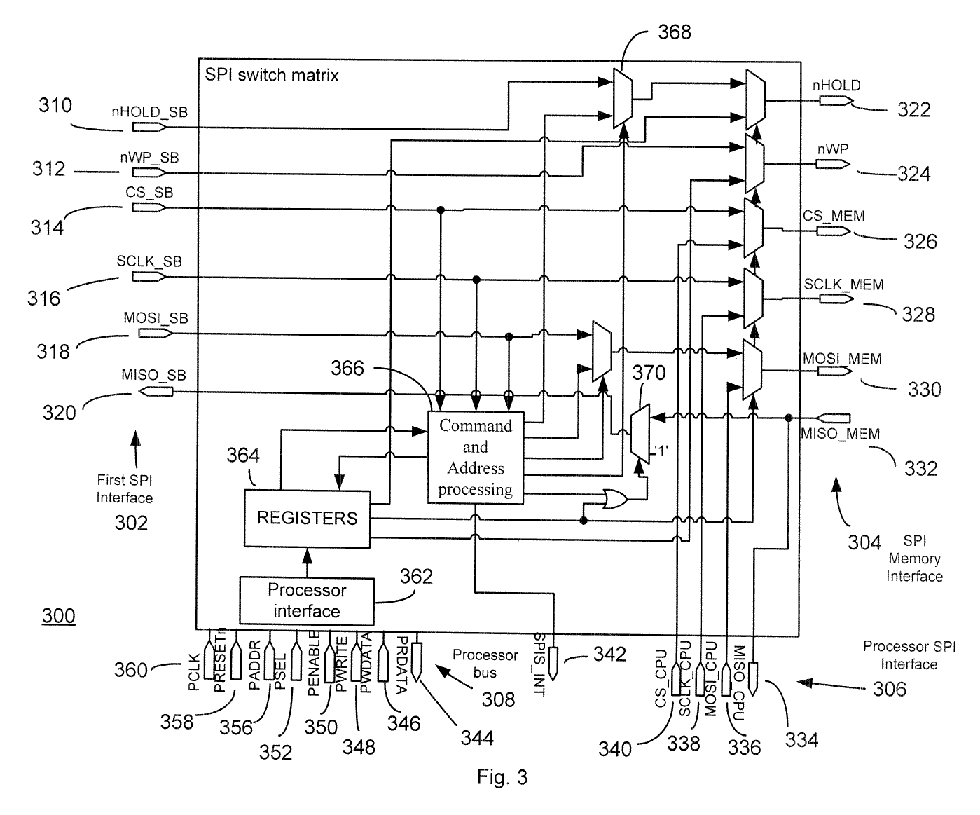

FIG. 3 is a simplified and exemplary block diagram of a switch matrix 300 similar to the switch matrix 202 of FIG. 2. The switch matrix 300 represents an embodiment tailored to a serial peripheral interface (SPI) bus. Similar embodiments for use with other data busses will be apparent to those skilled in the art. A first SPI interface 302 is used to interface with a standard component in a computer, such as a Southbridge chip, or equivalent, such as I/O interface 122 of FIG. 1. The Southbridge may be a standard, unmodified chipset component that has no awareness that it is not communicating directly with an SPI peripheral, such as a BIOS memory 133 of FIG. 1. A second SPI interface 304 may present a standard SPI interface to a memory device, such as BIOS memory 133. As with the Southbridge, the memory device may have no knowledge that it is not communicating directly with a single SPI bus master device, in a normal configuration. A processor SPI interface 306 allows the processor 212 to communicate over the second SPI interface 304. As shown, each signal line on the SPI interface may not appear on the processor SPI interface 306 because functions associated with those signal lines are managed internally. A processor bus 308 may connect to the address and data lines of the processor 212 allowing the processor to set up and manage the switch matrix 300.

The first SPI interface 302 may include a Southbridge hold input 310, a Southbridge write protect 312, a Southbridge chip select 314, a Southbridge clock 316, a Southbridge input 318 (so called memory output/southbridge input, or MOSI), and a Southbridge output 320 (memory input/southbridge output, or MISO).

The hold input 310 is also known as the reset line in other SPI implementations. This line is used to reset an SPI device and may be used to abort in-process operations. The write protect 312 puts an SPI device into a mode where some portion, or all, of its memory becomes read-only. For example, an ST Microelectronics (STM) M45PE80 memory, protects the first 256 pages of memory when its write protect signal is activated. The chip select 314 is used to activate the SPI device. An SPI device is a single drop network, meaning only one master and one device may be active at one time. The chip select 314 is active only when the selected device is to appear on the bus, when inactive, its output 320 is in a high impedance state. The clock 316 is used to clock data into and out of the device. All interface activity is controlled by the clock. In the exemplary STM device, data on the input 318 is latched on the rising edge of the clock while data on the output 320 changes after the falling edge. The input 318 is used for instructions, addresses, and data, each being clocked in a bit at a time using the clock 316. The output 320 shifts data out, for example, on the falling edge of the clock 316.

The second SPI interface 304 may have signal lines identical to those of the first SPI input, because of the transparency presented to devices connected on each side of the switch matrix 300. The SPI memory interface 304 may have a hold output 322, a write protect output 324, a chip select output 326, a clock output 328, a data output 330 (data going to the memory), and a data input 332 (data read from the memory).

The processor SPI interface 306 may include an output signal 334 (data from the memory), an input signal 336 (data to the memory), a clock input 338, and a chip select 340. An interrupt signal 342 goes from the switch matrix 300 to the processor, and is not strictly either a processor SPI interface 306 signal or a processor bus 308 signal.

The processor bus 308 may include read and write data lines 344 and 346 respectively. The processor bus 308 may also include a write signal 350 that is true when data is being read and false when data is being written, an enable signal 352, similar to a chip select, a select line 352 indicating a data transfer is required, a 6 pin address bus 356 that is a subset of the full processor address bus, a reset line 358 that resets the switch matrix 300, and a clock line 360 that is used for data clocking.

A processor interface 362 may provide impedance buffering and line drivers for the processor bus 308. Registers 364 may be used to store information about both command and address filtering. The command and address processing block 366 is a logic block for real time intervention into commands and requests made by via the first SPI interface 302.

The register 364 may include a list of commands that are allowed. For example, Table 1, following, lists representative commands that may be processed when received via the first SPI interface 302.

TABLE 1

| | | | ADDR. | |
|---|---|---|---|---|
| COMMAND | SHORT | OPCODE | CYCLES | DESCRIPTION |
| PBYTE | VOPC0 | x02 | 3 | To program one data |
| | | | | Byte |
| RDATA | VOPC1 | x03 | 3 | To Read memory |
| 64kERASE | VOPC2 | xD8 | 3 | To Erase 64 kByte of |
| | | | | memory array (one |
| | | | | memory chunk) |
| RSTATUS | VOPC3 | x05 | 0 | Read memory Status |
| | | | | Register |
| WSTATUS | VOPC4 | x01 | 0 | Write memory Status |
| | | | | Register |
| WENABLE | VOPC5 | x06 | 0 | Write Enable |
| WDISABLE | VOPC6 | x04 | 0 | Write Disable |
| READ-ID | VOPC7 | xAB | 3 | Read device ID (it is |
| | | | | the dedicated Coyote |
| | | | | ID, not the real SPI |
| | | | | flash ID) |
| — | VOPC8 | x00 | 0 | Custom command |
| — | VOPC9 | x00 | 0 | Custom command |
| — | VOPC10 | x00 | 0 | Custom command |
| — | VOPC11 | x00 | 0 | Custom command |

The read and write data commands, limited memory erase, read and writes to the status register, and write enable and disable commands are allowed in this example. Space for four additional commands is available for use as different applications or SPI devices may require. The additional commands may be programmed by the processor 212 using the processor bus 308.

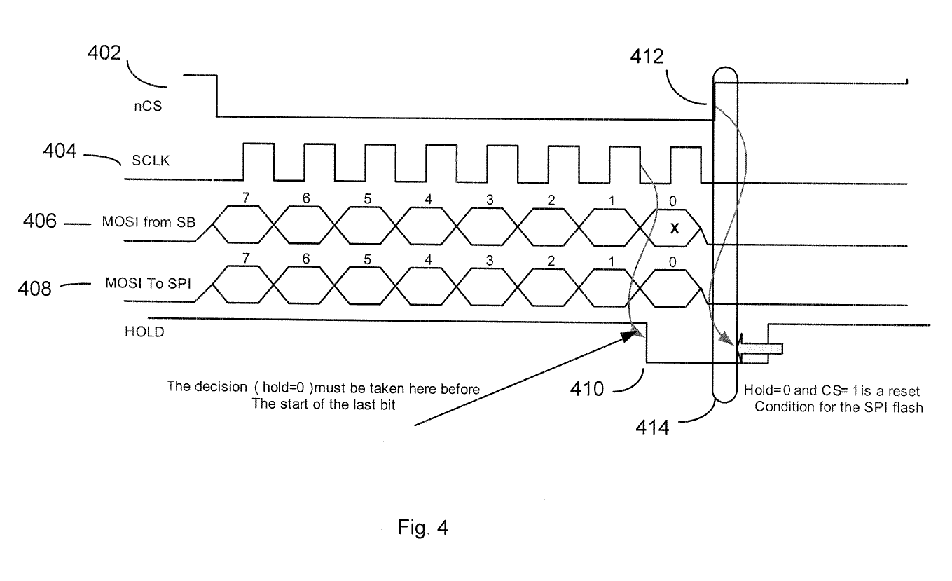

Turning to FIG. 4, command filtering is illustrated. A chip select line 402 may be brought low, indicating the memory 133 is to be activated via the SPI switch matrix 300. The clock signal 404 is used to begin clocking command data in from the first SPI interface 302, as shown by line 406. Line 408 represents the command data being clocked out to the second SPI interface 304. When bit seven is clocked in, an evaluation of the command may be made by comparing the command to allowed commands stored in the registers 364, as illustrated in Table 1. When the command is not allowed, the hold line 322 from the first SPI interface 302 may be over-ridden using multiplexer 368 to provide an alternate signal from the command and address processing block 366. Similarly, the chip select line 326 may be deactivated, causing the memory to go into reset.

Address substitution may be done in a similar fashion. When the first seven address bits have been processed, a 1 or 0 may be substituted for the final address bit, causing a read or write operation to be performed in another segment of memory, such as BIOS 2 228, instead of BIOS 1 226, as may be the case when operation is in the restricted mode vs. the unrestricted mode.

Because a command to read a manufacturer and device type from the memory 133 could return information about the memory 133 instead of the SPI switch matrix 300, the results of a READ ID request from the first SPI interface 302 is intercepted after completion of the command and substituted with a device identifier of the SPI switch matrix 300. The identifier may be programmed by the processor 212 over the processor bus 308 and stored in a register.

The processor may use the processor SPI bus 306 to program one or both of the BIOS memories 226, 228. The processor SPI interface 306 may be selected using the processor bus 308 to select multiplexer positions that couple the processor to the second SPI interface.

Another register may be used to store memory size and configuration depending upon the actual size of a memory coupled to the second SPI interface 304. Another register may be used to provide status information about the SPI switch matrix 300. Table 2 illustrates and describes a representative status information register. The status information register may be read only.

TABLE 2

| Bits | Name | Function |
|---|---|---|
| [31:24] | LASTDOP | Stores the last command received from the SB which vas recognized as a |
| | | Dangerous Op-code |
| [23:16] | LASTAD | Stores the Most Significant Byte of last address received from the SB SPI |
| | | interface |
| [15:8] | LASTOP | Stores the last command passed to SPI memory. |
| [7:5] | | Reserved, read zero, write has no effect |
| [4] | OPNFILT | OP-code Not filtered. When the bit is HIGH a command was passed to the flash |
| | | memory, though it was not recognized by the SPIswitch. The same signal is used |
| | | for interrupt generation. Once asserted it remains in HIGH state until the |
| | | corresponding bit in the Interrupt clear register is toggled |
| [3] | WNALLOW | Write Not ALLOWed. When the bit is HIGH since the SB has tried a write |
| | | operation on a protected memory area (HLM mode, when the current partition is |
| | | the candidate image) the command was blocked by the SPI switch. The same |
| | | signal is used for interrupt generation. Once asserted it remains in HIGH state |
| | | until the corresponding bit in the Interrupt clear register is toggled |
| [2] | HREQ | Hazardous SPI bus REQuest. When the bit is HIGH the SB has tried to master |
| | | the SPI bus, while the CPU is the enabled master. The same signal is used for |
| | | interrupt generation. Once asserted it remains in HIGH state until the |
| | | corresponding bit in the Interrupt clear register is toggled. |
| [1] | BCROSS | Boundary Cross. When the bit is HIGH the South Bridge has tried to read a |
| | | protected area and was blocked by address boundary check. The same signal is |
| | | used for interrupt generation. Once asserted it remains in HIGH state until the |
| | | corresponding bit in the Interrupt clear register is toggled. |
| [0] | DOPCODE | Dangerous OP-CODE, when HIGH the SPI switch filtered out the incoming |
| | | command as it was not recognized. The same signal is used for interrupt |
| | | generation. Once asserted it remains in HIGH state until the corresponding bit in |
| | | the Interrupt clear register is toggled. |

Certain conditions may generate interrupts on the interrupt line 342. Referring to Table 2, some of these conditions may include the OPNFILT, op-code not filtered condition, the WNALLOW, write not allowed condition, the HREQ, hazardous SPI bus request, the BCROSS, boundary cross condition, and the DOPCODE, dangerous op-code condition. When an interrupt is asserted, an interrupt register (not depicted) may be read to determine the source of activation of the interrupt line 342. When the interrupt has been processed, a write to an interrupt clear register (not depicted) may be used to clear the interrupt.

When conditions such as a dangerous op-code are detected, an appropriate error code may be returned via the first SPI interface 302. A processor or other device making the request may be programmed to address the error condition.

A special condition requiring management is a sequential data request that may roll over the top of memory to the bottom of memory (or vice versa). When such as command is activated, the SPI switch matrix may provide valid memory data unless the roll-over address is in an area of memory containing an alternate BIOS or other restricted memory. When the address moves into an restricted space, the multiplexer 370 may be switched and the value ‘1’ supplied.

The use of the SPI switch as part of a security module for managing selective access to gives designers and developers a tool for supporting multiple BIOS memories both securely and transparently, especially when the memory and SPI switch are integrated into a multi-chip module (MCM) or other single package. Existing chipset components and computer architectures are unaffected by the use of the SPI switch, and other than possible error handling code, may be completely unaware of the existence of the SPI switch or security module.

The innovative design provides for management of conditions such as different memory sizes and types, ID substitution, command blocking and the like. The use of the security module and SPI switch provide a simple, yet comprehensive capability for management of operation in both an unrestricted operating mode and a restricted operating mode, as may be called for in a pay-per-use or metered use business model.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of managing communications with an SPI slave device in a computer comprising:
disposing a switch coupling a first SPI master to the SPI slave device;
connecting a processor to the switch; and
filtering data from the first SPI master to the SPI slave device under the control of the processor.

2. The method of claim 1, wherein filtering data from the first SPI master to the SPI slave device comprises:
monitoring a request address targeting the SPI slave device; and
substituting an absolute address for use by the SPI slave device.

3. The method of claim 2, wherein substituting the absolute address comprises:
disposing a first and a second basic input/output system (BIOS) in the SPI slave device;
determining when the request address is for the first BIOS;
determining that a condition exists requiring use of a second BIOS; and
substituting the absolute address pointing to the second BIOS.

4. The method of claim 1, wherein filtering data from the first SPI master to the SPI slave device comprises:
monitoring a requested command targeting the slave device;
comparing the requested command to an allowed list; and
allowing the requested command only when the requested command appears on the allowed list.

5. The method of claim 4, wherein the requested command is a bulk erase command.

6. The method of claim 4, further comprising sending allowed list data from the processor to the switch.

7. The method of claim 1, wherein connecting the processor to the switch comprises:
connecting the processor to a data and address interface of the switch; and
connecting the processor to an SPI interface allowing the processor to act as a second SPI master.

8. A serial peripheral interface (SPI) module comprising:
a first SPI port for coupling to an SPI master;
a second SPI port;
an SPI slave coupled to the second SPI port;
a processor; and
a switching apparatus coupled to the processor, the first SPI port, and the second SPI port, the switching apparatus responsive to signals from the processor for selectively coupling the second SPI port to the first SPI port.

9. The SPI module of claim 8, further comprising a logic block for evaluating validity of a command received via the first SPI port, the logic block including an output for blocking an invalid command received via the first SPI port.

10. The SPI module of claim 9, further comprising a register programmable via the processor that stores a list of invalid commands.

11. The SPI module of claim 8, further comprising an address translator for transparently re-addressing messages received at the first SPI port destined for the SPI slave.

12. The SPI module of claim 11, wherein the address translator comprises multiple chip select lines allowing re-addressing across multiple physical SPI slaves.

13. The SPI module of claim 8, wherein the SPI slave is a memory storing executable code for at least one basic input/output system (BIOS).

14. The SPI module of claim 8, further comprising a second bus interface coupled to the processor, the second bus interface one of a low pin count (LPC) bus and a peripheral component interface (PCI) bus.

15. The SPI module of claim 8, wherein the switching apparatus comprises a set of multiplexers for routing SPI control and data signals to the SPI slave from one of the first SPI port and the processor.

16. A computer adapted for use in a restricted mode and an unrestricted mode comprising:
a first processor;
an input/output (I/O) controller coupled to the processor via a main bus;
a memory storing at least one basic input/output system (BIOS) coupled to the I/O controller; and
a switching module coupled between the memory and the I/O controller; the switching module comprising:
a second processor;
an I/O controller interface;
a memory interface; and
a switch matrix coupled to the second processor, the I/O controller interface, and the memory interface responsive to the second processor for coupling a first BIOS in the memory to the I/O controller when the computer is to be used in the unrestricted mode.
to.

17. The computer of claim 16, wherein the switch matrix further comprises a logic unit that manages address translation for requests received from the I/O controller.

18. The computer of claim 16, wherein the switch matrix further comprises a logic unit that manages command filtering for requests received from the I/O controller.

19. The computer of claim 18, wherein the switch matrix further comprises a register storing a set of requests that are to be filtered when received from the I/O controller.

20. The computer of claim 19, wherein the register is coupled to and receives programming instructions from the second processor.
